(19) United States
(12) Patent Application Publication
(10) Pub. No.: US 2026/0223198 A1
(43) Pub. Date: Jul. 30, 2026

(54) EARLY SRS TRANSMISSION

(71) Applicant: Samsung Electronics Co., Ltd., Suwon-si (KR)

(72) Inventors: Anil Agiwal, McKinney, TX (US); Emad Nader Farag, Flanders, NJ (US); Eko Onggosanusi, Coppell, TX (US); Kyeongin Jeong, Frisco, TX (US); Shiyang Leng, Little Elm, TX (US)

(21) Appl. No.: 19/454,356

(22) Filed: Jan. 20, 2026

Related U.S. Application Data
(60) Provisional application No. 63/751,675, filed on Jan. 30, 2025.
(60) Provisional application No. 63/843,452, filed on Jul. 14, 2025.

(51) Int. Cl. H04W 74/0836; H04L 5/00; H04W 8/22

(52) U.S. Cl. CPC H04W 74/0836; H04L 5/0051; H04W 8/22

(57) ABSTRACT

A method of operating a user equipment (UE) includes receiving one or more random access (RA) resource configurations. Each RA resource configuration is associated with one or more (x, y) values corresponding to a sounding reference signal (SRS) antenna switching capability TxRy of the UE. The method also includes initiating one of a four-step or two-step RA procedure, during the RA procedure, transmitting a Message 1 (Msg1) or Message A (MsgA) indicating the one or more (x, y) values corresponding to the SRS antenna switching capability TxRy of the UE, and transmitting an SRS according to an SRS resource configuration for an (x, y) value indicated in the Msg1 or MsgA.

### CROSS-REFERENCE TO RELATED APPLICATION(S) AND CLAIM OF PRIORITY

This application claims priority under 35 U.S.C. § 119 (e) to U.S. Provisional Patent Application No. 63/751,675 filed on Jan. 30, 2025, and U.S. Provisional Patent Application No. 63/843,452 filed on Jul. 14, 2025. The above-identified provisional patent applications are hereby incorporated by reference in their entirety.

### TECHNICAL FIELD

This disclosure relates generally to wireless networks. More specifically, this disclosure relates to early sounding reference signal (SRS) transmission.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for early SRS transmission.

In one embodiment, a method of operating a user equipment (UE) is provided. The method includes receiving one or more random access (RA) resource configurations. Each RA resource configuration is associated with one or more (x, y) values corresponding to a sounding reference signal (SRS) antenna switching capability TxRy of the UE. The method also includes initiating one of a four-step or two-step RA procedure, during the RA procedure, transmitting a Message 1 (Msg1) or Message A (MsgA) indicating the one or more (x, y) values corresponding to the SRS antenna switching capability TxRy of the UE, and transmitting an SRS according to an SRS resource configuration for an (x, y) value indicated in the Msg1 or MsgA.

In another embodiment, a method of operating a base station (BS) is provided. The method includes transmitting, to a UE, one or more RA resource configurations. Each RA resource configuration is associated with one or more (x, y) values corresponding to an SRS antenna switching capability TxRy of the UE. The method also includes, during one of a four-step or two-step RA procedure initiated by the UE, receiving a Msg1 or MsgA from the UE indicating the one or more (x, y) values corresponding to the SRS antenna switching capability TxRy of the UE, and receiving an SRS according to an SRS resource configuration for an (x, y) value indicated in the Msg1 or MsgA.

In yet another embodiment, an electronic device is provided. The electronic device includes at least one processor including processing circuitry, and memory storing instructions. The instructions, when executed by the at least one processor individually or collectively, cause the electronic device to receive one or more RA resource configurations. Each RA resource configuration is associated with one or more (x, y) values corresponding to an SRS antenna switching capability TxRy of the electronic device. The instructions, when executed by the at least one processor individually or collectively, also cause the electronic device to initiate one of a four-step or two-step RA procedure, during the RA procedure, transmit a Msg1 or MsgA indicating the one or more (x, y) values corresponding to the SRS antenna switching capability TxRy of the electronic device, and transmit an SRS according to an the SRS resource configuration for an (x, y) value indicated in the Msg1 or MsgA.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for early SRS transmission according to embodiments of the present disclosure;

FIG. 5 illustrates another example procedure for early SRS transmission according to embodiments of the present disclosure;

FIG. 6 illustrates another example procedure for early SRS transmission according to embodiments of the present disclosure;

FIG. 7 illustrates another example procedure for early SRS transmission according to embodiments of the present disclosure;

FIG. 8 illustrates an example procedure for determining an early CSI/SRS trigger according to embodiments of the present disclosure;

FIG. 9 illustrates another example procedure for determining an early CSI/SRS trigger according to embodiments of the present disclosure;

FIG. 10 illustrates another example procedure for determining an early CSI/SRS trigger according to embodiments of the present disclosure;

FIG. 11 illustrates another example procedure for determining an early CSI/SRS trigger according to embodiments of the present disclosure;

FIG. 12 illustrates an example method for early SRS transmission according to embodiments of the present disclosure; and

FIG. 13 illustrates another example method for early SRS transmission according to embodiments of the present disclosure.

### DETAILED DESCRIPTION

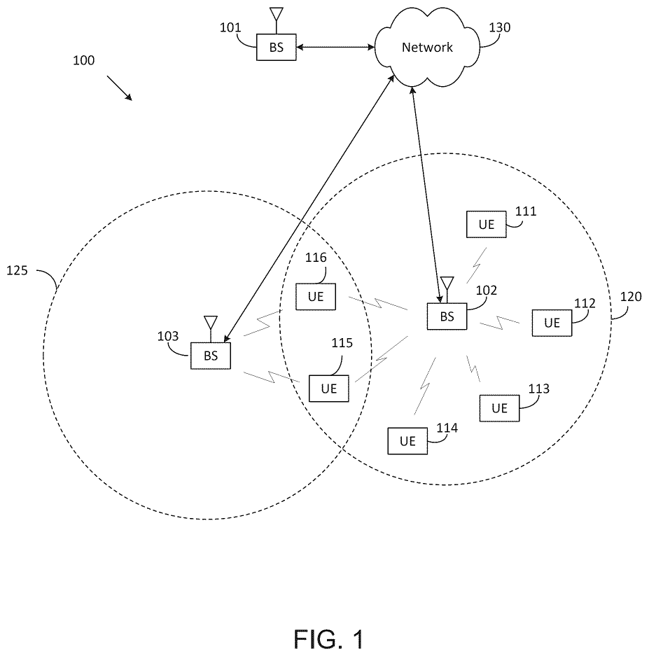

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for early SRS transmission. In certain embodiments, one or more of the gNBs 101-103 includes circuitry, programing, or a combination thereof, to support early SRS transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

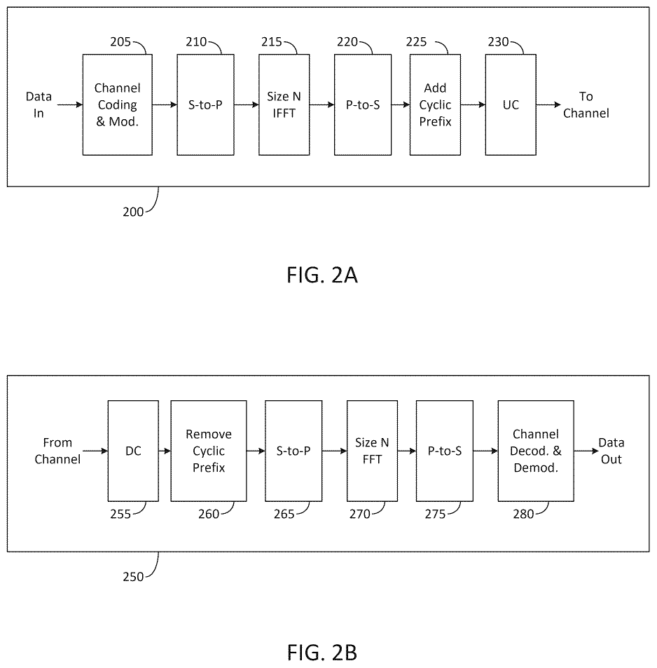

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support early SRS transmission as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

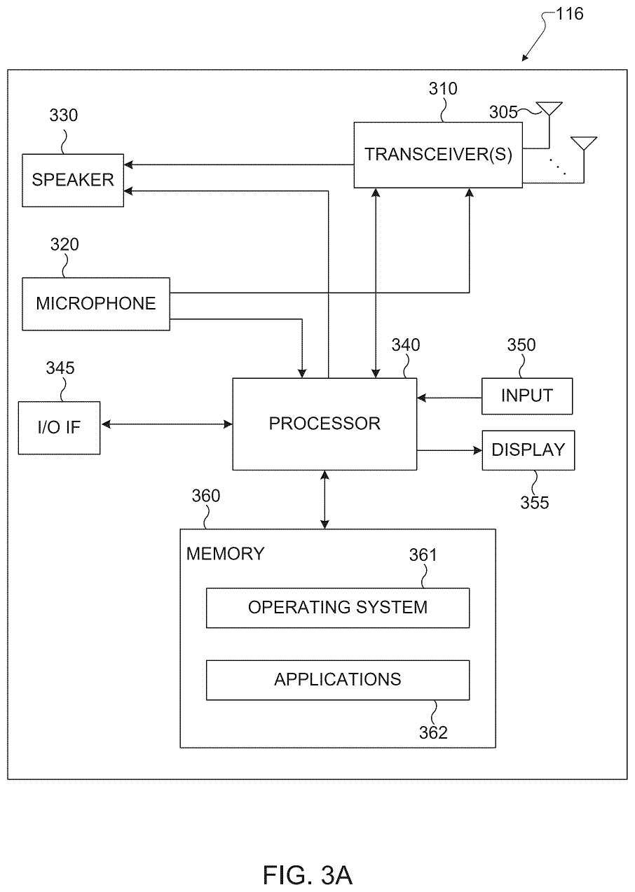

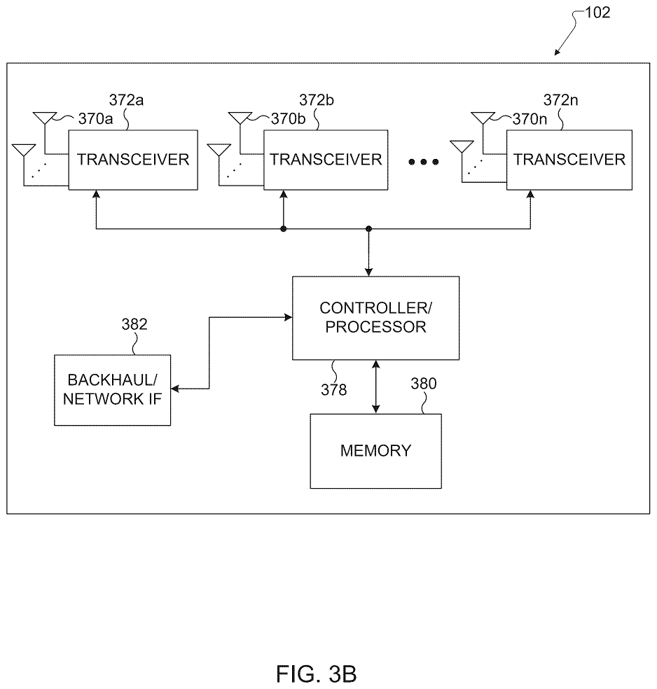

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for early SRS transmission as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support early SRS transmission as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+ duration, where the slot with number ‘x’ in a radio frame with number ‘y’ satisfies the equation below: (y*(number of slots in a radio frame)+x-Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random-access procedure are supported such as contention based random access, contention free random access and each of these can be one of 2 step or 4 step random access.

In contention based random access (CBRA), also referred as 4 step CBRA, the UE first transmits a random access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, (i.e., RA preamble); OS s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for a normal UL [NUL] carrier and 1 for a supplementary UL [SUL] carrier. Several RARs for various Random-access preambles detected by the gNB can be multiplexed in the same RAR media access control (MAC) protocol data unit (PDU) by the gNB. A RAR in MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select a random access resource [preamble/RACH occasion]) and transmits the RA preamble. A backoff may be applied before going back to first step.

If the RAR corresponding to its RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to first step.

For performing CBRA, a RACH configuration is signaled in system information (i.e., SIB 1) and in dedicated RRC signaling. The RACH configuration in SIB 1 is used by the UE in RRC IDLE and RRC INACTIVE states.

The contention based RACH configuration includes prach-ConfigurationIndex which indicates the available set of PRACH occasions for the transmission of the random access preamble. The number of PRACH occasions in the PRACH configuration period is pre-defined for each PRACH configuration index. The PRACH configuration period for each PRACH configuration index is also pre-defined. A pre-defined PRACH configuration table lists a number of configurations, wherein each configuration indicates the number of PRACH occasions in the PRACH configuration period, the PRACH configuration period, the location of PRACH occasions in the PRACH configuration period, etc. The PRACH configuration index is an index to an entry in this PRACH configuration table.

The contention based RACH configuration also includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).

Based on ssb-perRACH-Occasion and the number of SSBs transmitted in cell, PRACH occasions configured by prach-ConfigurationIndex are mapped to SSBs. The number of SSBs transmitted in the cell is signaled by the gNB in system information and dedicated RRC signaling messages. PRACH occasions are mapped to SSBs over an association period. The association period starting from SFN 0 is the period in which all SSBs are mapped to PRACH occasions at least once. In an example, the association period can be equal to {1, 2, 4, 8, 16} PRACH Configuration periods.

If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N=1, per valid PRACH occasion start from preamble index

$$n \cdot {N}_{preamble}^{total} / N$$

where

$${N}_{preamble}^{total}$$

is provided by totalNumberOfRA-Preambles and is an integer multiple of N. totalNumberOfRA-Preambles is signaled by gNB in RACH configuration.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

A sounding reference signal (SRS) is an uplink reference signal that is used for sounding (i.e., channel state or quality estimation) the UL channel between the UE and the gNB. In case of reciprocity between UL and DL, the channel sounding of the UL channel can also be used for link adaptation and precoding on the DL channel from the gNB to the UE. SRS is transmitted independent of data transmissions on the UL. The SRS usage can be one of: beamManagement, codebook, nonCodebook, and antennaSwitching, which is in addition to SRS for positioning.

When a UE is in an RRC_IDLE state or RRC_INACTIVE state, and data arrives at the network for the UE, or data arrives at the UE for the network, the UE through an RRC setup procedure or RRC reconfiguration procedure transitions to the RRC_CONNECTED state. After transition to the RRC_CONNECTED state the network can trigger an SRS transmission from the UE for channel quality estimation, after the UE context/capability is established and the UE can start transmitting and receiving data. The SRS triggered can be wideband SRS or sub-band SRS, which would utilize several SRS transmission instances to provide an estimate of the channel quality of the full bandwidth. This process (i.e., the estimation of the channel quality), can take tens of milli-seconds, and even longer with sub-band SRS. Data transmission/reception can be delayed until the channel quality has been estimated using SRS, hence increasing latency. Alternatively, data transmission/reception can proceed in parallel with the SRS transmission and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB for the UE.

To mitigate these inefficiencies, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. In other words, there is a benefit for triggering and/or transmitting SRS early.

In some embodiments, a UE can indicate an early SRS capability using a random access preamble transmitted during a random access procedure. In embodiments such as these the network may configure random access preambles/ROs for the early SRS. Various embodiments of the disclosure provide mechanisms for signaling/configuring which random access preambles/ROs are for early SRS.

A random access procedure may be initiated by a UE for several reasons. Various embodiments of the present disclosure provide mechanism for a UE to determine whether early SRS is applicable for a particular random access procedure. In some embodiments, these mechanisms may correspond with a specific type of early SRS capability.

Several random access configurations/random access resource sets can be configured by system information/an RRC message for the BWP used for an initiated random access procedure. Various embodiments of the disclosure provide mechanisms for a UE to select a random access resource set for early SRS.

Various embodiments of the present disclosure provide mechanisms (e.g., a detailed signaling design) for triggering early SRS and/or CSI for a mobile terminated call (e.g., for a case where DL data becomes available at the network side for the UE).

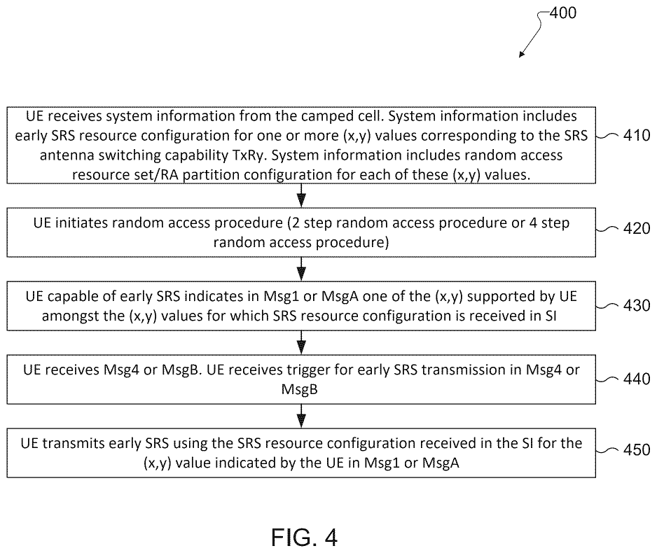

FIG. 4 illustrates an example procedure for early SRS transmission 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for early SRS transmission could be used without departing from the scope of this disclosure.

In the example of FIG. 4, the procedure 400 begins at operation 410. At operation 410, a UE (such as UE 116 of FIG. 1) receives UE receives system information (SI) from the camped cell of the UE (e.g., from a BS such as gNB 102 of FIG. 1). The SI includes an early SRS resource configuration for one or more (x, y) values corresponding to the SRS antenna switching capability TxRy of the UE. For example, in some embodiments, TxRy can be one or more of the following: one transmit and one receive (1T1R), 1T2R, 1T4R, 2T2R, 2T4R, 4T4R, 1T6R, 2T6R, 1T8R, 2T8R, 4T8R, 8T8R, 3T3R, 3T6R. The SI includes random access resource set/RA partition configuration(s) for these (x, y) values for which early SRS resource configuration is included in the System information. At operation 420, the UE initiates one of a two-step or a four-step random access procedure.

In some embodiments, at operation 430, during the random access procedure, if the UE is capable of early SRS, the UE indicates in a Message 1 (Msg1) or Message A (MsgA) one of the (x, y) values supported by the UE amongst the (x, y) value(s) for which SRS resource configuration(s) are received in SI. To provide this indication, the UE selects the random access resource set/RA partition corresponding to one of the (x, y) values supported by the UE amongst the (x, y) values for which SRS resource configuration is received in the SI. The UE then selects a random access preamble and RACH occasion from the selected random access resource set/RA partition and transmits the random access preamble to the gNB. At operation 440, during the random access procedure, the UE receives a Message 4 (Msg4) or Message B (MsgB). The UE may receive a trigger for early SRS transmission in the Msg4 (e.g., an RRC message or MAC CE or DCI scheduling the Msg4) or MsgB (e.g., an RRC message or MAC CE or DCI scheduling MsgB) or after the Msg4/MsgB. At operation 450, after receiving the trigger for early SRS/Msg4 or MsgB, the UE transmits early SRS using the SRS resource configuration received in the SI for the (x, y) value indicated by the UE in the Msg1 or MsgA.

Alternatively, in some embodiments, at operation 430, during the random access procedure, if the UE is capable of early SRS, the UE indicates in a Msg1 or MsgA a plurality of the (x, y) values supported by the UE amongst the (x, y) values for which SRS resource configuration is received in the SI. To provide this indication, the UE selects the random access resource set/RA partition corresponding to the plurality of the (x, y) values supported by the UE amongst the (x, y) values for which SRS resource configuration is received in SI. The UE then selects a random access preamble and RACH occasion from the selected random access resource set/RA partition and transmits the random access preamble to the gNB. At operation 440, in the Msg4/MsgB the network/gNB indicates one of the (x, y) amongst the (x, y) values indicated by the UE in the Msg1 or MsgA. At operation 450, after receiving the Msg4/MsgB, the UE transmits early SRS using the SRS resource configuration received in the SI for the (x, y) value indicated in the Msg4/MsgB.

Although FIG. 4 illustrates one example procedure for early SRS transmission 400, various changes may be made to FIG. 4. For example, while shown as a series of operations, various operations in FIG. 4 could overlap, occur in parallel, occur in a different order, occur any number of times, be omitted, or replaced by other operations.

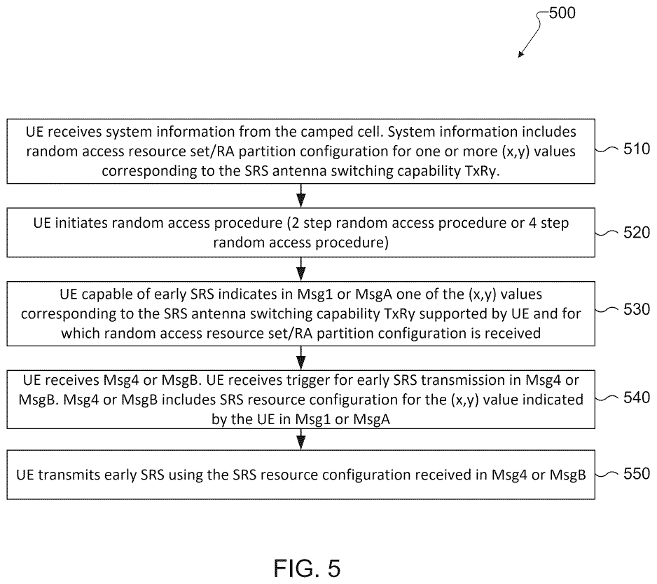

FIG. 5 illustrates another example procedure for early SRS transmission 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for early SRS transmission could be used without departing from the scope of this disclosure.

In the example of FIG. 5, the procedure 500 begins at operation 510. At operation 510, a UE (such as UE 116 of FIG. 1) receives UE receives SI from the camped cell of the UE (e.g., from a BS such as gNB 102 of FIG. 1). The SI includes a random access resource set/RA partition configuration(s) for one or more (x, y) values corresponding to the SRS antenna switching capability TxRy of the UE. For example, in some embodiments, TxRy can be one or more of the following: 1T1R, 1T2R, 1T4R, 2T2R, 2T4R, 4T4R, 1T6R, 2T6R, 1T8R, 2T8R, 4T8R, 8T8R, 3T3R, 3T6R. At operation 520, the UE initiates one of a two-step or a four-step random access procedure.

In some embodiments, at operation 530, during the random access procedure, if the UE is capable of early SRS, the UE indicates in a Msg1 or MsgA one of the (x, y) values corresponding to the SRS antenna switching capability TxRy supported by the UE. To provide this indication, the UE selects the random access resource set/RA partition corresponding to one of the (x, y) values corresponding to the SRS antenna switching capability TxRy supported by UE. The UE then selects a random access preamble and RACH occasion from the selected random access resource set/RA partition and transmits the random access preamble to the gNB. At operation 540, during the random access procedure, the UE receives a Msg4 or MsgB. The UE receives a trigger for early SRS transmission in the Msg4 (which can be an RRC message or MAC CE or DCI scheduling the Msg4) or MsgB (which can be an RRC message or MAC CE or DCI scheduling the MsgB). The Msg4 or MsgB includes an SRS resource configuration for the (x, y) value indicated by the UE in the Msg1 or MsgA. In some embodiments, the trigger for the early SRS transmission in the Msg4 (which can be an RRC message or MAC CE or DCI scheduling the Msg4) or MsgB can be implicit (e.g., the presence of an SRS resource configuration in Msg4/MsgB can be the trigger). At operation 550, after receiving the trigger or Msg4 or MsgB, the UE transmits early SRS using the SRS resource configuration received in the Msg4 or MsgB.

Alternatively, in some embodiments, at operation 530, during the random access procedure, if the UE is capable of early SRS, the UE indicates in a Msg1 or MsgA a plurality of the (x, y) values supported by the UE. To provide this indication, the UE selects the random access resource set/RA partition corresponding to the plurality of the (x, y) values supported by the UE. The UE then selects a random access preamble and RACH occasion from the selected random access resource set/RA partition and transmits the random access preamble to the gNB. At operation 540, in the Msg4/MsgB network/gNB indicates the SRS resource configuration and associated (x, y) value from one of the (x, y) values indicated by the UE in the Msg1 or MsgA. At operation 550, after receiving the Msg4/MsgB, the UE transmits early SRS using the SRS resource configuration received in the Msg4/MsgB.

Although FIG. 5 illustrates one example procedure for early SRS transmission 500, various changes may be made to FIG. 5. For example, while shown as a series of operations, various operations in FIG. 5 could overlap, occur in parallel, occur in a different order, occur any number of times, be omitted, or replaced by other operations.

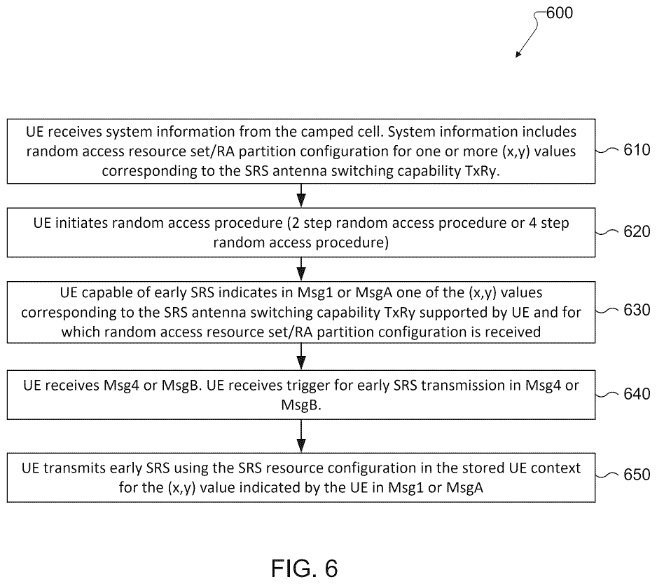

FIG. 6 illustrates another example procedure for early SRS transmission 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for early SRS transmission could be used without departing from the scope of this disclosure.

In the example of FIG. 6, the procedure 600 begins at operation 610. At operation 610, a UE (such as UE 116 of FIG. 1) receives UE receives SI from the camped cell of the UE (e.g., from a BS such as gNB 102 of FIG. 1). The SI includes random access resource set/RA partition configuration(s) for one or more (x, y) values corresponding to the SRS antenna switching capability TxRy of the UE. For example, in some embodiments, TxRy can be one or more of the following: 1T1R, 1T2R, 1T4R, 2T2R, 2T4R, 4T4R, 1T6R, 2T6R, 1T8R, 2T8R, 4T8R, 8T8R, 3T3R, 3T6R. At operation 620, the UE initiates one of a two-step or a four-step random access procedure.

In some embodiments, at operation 630, during the random access procedure, if the UE is capable of early SRS, the UE indicates in a Msg1 or MsgA one of the (x, y) values corresponding to the SRS antenna switching capability TxRy supported by the UE. To provide this indication, the UE selects the random access resource set/RA partition corresponding to one of the (x, y) values corresponding to the SRS antenna switching capability TxRy supported by UE. The UE then selects a random access preamble and RACH occasion from the selected random access resource set/RA partition and transmits the random access preamble to the gNB. At operation 640, during the random access procedure, the UE receives a Msg4 or MsgB. The UE may receive a trigger for early SRS transmission in the Msg4 (which can be an RRC message or MAC CE or DCI scheduling the Msg4) or MsgB (which can be an RRC message or MAC CE or DCI scheduling the MsgB). At operation 640, after receiving the trigger or Msg4/MsgB, the UE transmits early SRS using the SRS resource configuration in the stored UE context for the (x, y) value indicated by the UE in Msg1 or MsgA. The SRS resource configuration in the stored UE context may be received by the UE in the RRC release message releasing the RRC connection. The SRS resource configuration in the stored UE context may be received by the UE in the RRC release message suspending the RRC connection or releasing the RRC connection to the RRC inactive state. The SRS resource configuration in the stored UE context may be received by the UE while the UE was in the RRC_CONNECTED state.

Alternatively, in some embodiments, at operation 630, during the random access procedure, if the UE is capable of early SRS, the UE indicates in a Msg1 or MsgA a plurality of the (x, y) values supported by the UE. To provide this indication, the UE selects the random access resource set/RA partition corresponding to the plurality of the (x, y) values supported by the UE. The UE then selects a random access preamble and RACH occasion from the selected random access resource set/RA partition and transmits the random access preamble to the gNB. At operation 640, in the Msg4/MsgB the network/gNB indicates an (x, y) value for early SRS transmission from one of the (x, y) values indicated by the UE in the Msg1 or MsgA. At operation 650, after receiving the Msg4/MsgB, the UE transmits early SRS using the SRS resource configuration in the stored UE context for the (x, y) value indicated by the gNB in the MsgB or Msg4.

Although FIG. 6 illustrates one example procedure for early SRS transmission 600, various changes may be made to FIG. 6. For example, while shown as a series of operations, various operations in FIG. 6 could overlap, occur in parallel, occur in a different order, occur any number of times, be omitted, or replaced by other operations.

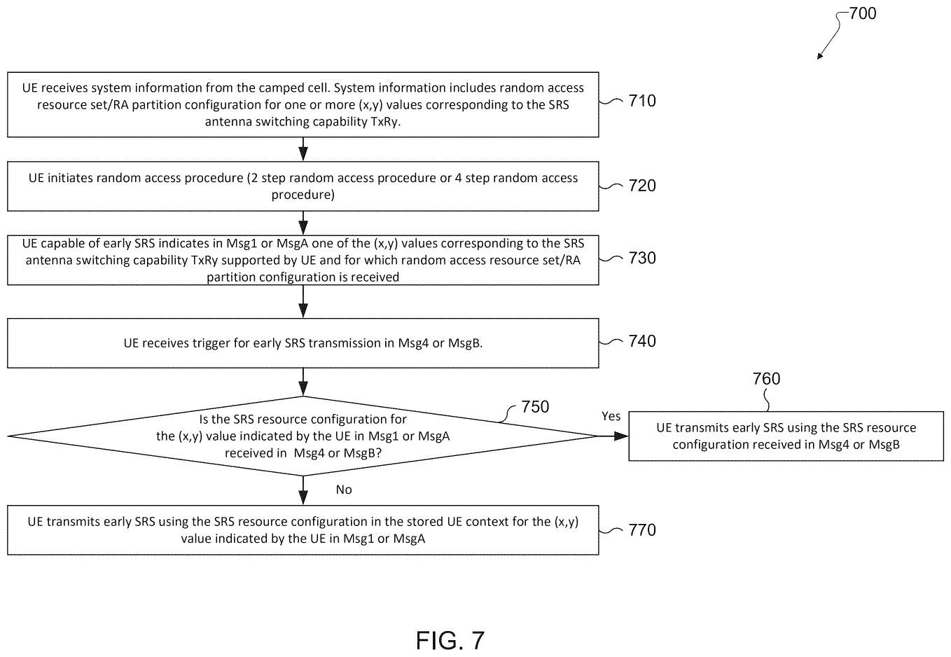

FIG. 7 illustrates another example procedure for early SRS transmission 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for early SRS transmission could be used without departing from the scope of this disclosure.

In the example of FIG. 7, the procedure 700 begins at operation 710. At operation 710, a UE (such as UE 116 of FIG. 1) receives UE receives SI from the camped cell of the UE (e.g., from a BS such as gNB 102 of FIG. 1). The SI includes a random access resource set/RA partition configuration(s) for one or more (x, y) values corresponding to the SRS antenna switching capability TxRy of the UE. For example, in some embodiments, TxRy can be one or more of the following: 1T1R, 1T2R, 1T4R, 2T2R, 2T4R, 4T4R, 1T6R, 2T6R, 1T8R, 2T8R, 4T8R, 8T8R, 3T3R, 3T6R. At operation 720, the UE initiates one of a two-step or a four-step random access procedure.

In some embodiments, at operation 730, during the random access procedure, if the UE is capable of early SRS, the UE indicates in a Msg1 or MsgA one of the (x, y) values corresponding to the SRS antenna switching capability TxRy supported by the UE. To provide this indication, the UE selects the random access resource set/RA partition corresponding to one of the (x, y) values corresponding to the SRS antenna switching capability TxRy supported by UE. The UE then selects a random access preamble and RACH occasion from the selected random access resource set/RA partition and transmits the random access preamble to the gNB. At operation 740, during the random access procedure, the UE receives a Msg4 or MsgB. At operation 750, the UE checks if the SRS resource configuration for the (x, y) value indicated by the UE in Msg1 or MsgA is received in the Msg4 or MsgB. If the SRS resource configuration for the (x, y) value indicated by the UE in the Msg1 or MsgA is received in the Msg4 or MsgB, at operation 760 the UE transmits early SRS using the SRS resource configuration received in the Msg4 or MsgB. If the SRS resource configuration for the (x, y) value indicated by the UE in the Msg1 or MsgA is not received in the Msg4 or MsgB, at operation 770 the UE transmits early SRS using the SRS resource configuration in the stored UE context for the (x, y) value indicated by the UE in the Msg1 or MsgA. The SRS resource configuration in the stored UE context may be received by the UE in the RRC release message releasing the RRC connection. The SRS resource configuration in the stored UE context may be received by the UE in the RRC release message suspending the RRC connection or releasing the RRC_connection to the RRC inactive state. The SRS resource configuration in the stored UE context may be received by the UE while the UE was in the RRC_CONNECTED state.

Alternatively, in some embodiments, at operation 730, during the random access procedure, if the UE is capable of early SRS, the UE indicates in a Msg1 or MsgA a plurality of the (x, y) values supported by the UE. To provide this indication, the UE selects the random access resource set/RA partition corresponding to the plurality of the (x, y) values supported by the UE. The UE then selects a random access preamble and RACH occasion from the selected random access resource set/RA partition and transmits the random access preamble to the gNB. After receiving the Msg4/MsgB (operation 740), at operation 750 the UE checks if the SRS resource configuration for one of the (x, y) values amongst the plurality of (x, y) values indicated by the UE in the Msg1 or MsgA is received in the Msg4 or MsgB. If the SRS resource configuration for one of the (x, y) values amongst the plurality of (x, y) values indicated by the UE in the Msg1 or MsgA is received in the Msg4 or MsgB, at operation 760, the UE transmits early SRS using the SRS resource configuration received in the Msg4 or MsgB. If the SRS resource configuration for one of the (x, y) values amongst the plurality of (x, y) values indicated by the UE in the Msg1 or MsgA is not received in the Msg4 or MsgB and a (x, y) value amongst the plurality of (x, y) values indicated by the UE in the Msg1 or MsgA is received in the Msg4 or MsgB, at operation 770 the UE transmits early SRS using the SRS resource configuration in the stored UE context for the (x, y) value indicated by the gNB in the MsgB or Msg4. The SRS resource configuration in the stored UE context may be received by the UE in the RRC release message releasing the RRC connection. The SRS resource configuration in the stored UE context may be received by the UE in the RRC release message suspending the RRC connection or releasing the RRC_connection to the RRC_inactive state. The SRS resource configuration in the stored UE context may be received by the UE while the UE was in the RRC_CONNECTED state.

Although FIG. 7 illustrates one example procedure for early SRS transmission 700, various changes may be made to FIG. 7. For example, while shown as a series of operations, various operations in FIG. 7 could overlap, occur in parallel, occur in a different order, occur any number of times, be omitted, or replaced by other operations.

In some embodiments, the random access resource set/RA partition configuration for different early SRS antenna switching (TxRy) capability values can be signaled in the BWP configuration (of the initial uplink BWP) as follows:

A BWP-UplinkCommon IE in the BWP configuration includes one or more rach-ConfigCommon/RACH-ConfigCommonTwoStepRA IEs. The rach-ConfigCommon/RACH-ConfigCommonTwoStepRA IEs include a list of one or more FeatureCombinationPreambles IEs. The FeatureCombinationPreambles IE includes a FeatureCombination IE. The FeatureCombination IE may include an earlySRS field set to TRUE. If the FeatureCombination IE in a FeatureCombinationPreambles IE includes an earlySRS (or earlySRS-r20) field set to TRUE, the preambles configured by this FeatureCombinationPreambles IE are associated with an early SRS transmission feature. The FeatureCombinationPreambles IE may include an early SRS antenna switching capability (Early-SRSTxRx or Early-SRSTxRx-r20). Early-SRSTxRx may be set to one of the TxRy values from 1T1R, 1T2R, 1T4R, 2T2R, 2T4R, 4T4R, 1T6R, 2T6R, 1T8R, 2T8R, 4T8R, 8T8R, 3T3R, 3T6R or from a subset of 1T1R, 1T2R, 1T4R, 2T2R, 2T4R, 4T4R, 1T6R, 2T6R, 1T8R, 2T8R, 4T8R, 8T8R, 3T3R, 3T6R. In some embodiments, a FeatureCombinationPreambles IE may include an early SRS antenna switching capability only if a FeatureCombination IE in a FeatureCombinationPreambles IE includes an earlySRS field set to TRUE.

In some embodiments, for a number ‘N’ SRS antenna switching capabilities, the network can signal ‘N’ FeatureCombinationPreambles IEs in a rach-ConfigCommon/RACH-ConfigCommonTwoStepRA IE and include earlySRS set to TRUE in these FeatureCombinationPreambles IEs and indicate a separate SRS antenna switching capability in each of these ‘N’ FeatureCombinationPreambles IEs.

In some embodiments, for a number ‘N’ SRS antenna switching capabilities, the network can signal ‘N’ rach-ConfigCommon/RACH-ConfigCommonTwoStepRA IEs, indicate earlySRS set to TRUE in a FeatureCombinationPreambles IE in each of these rach-ConfigCommon/RACH-ConfigCommonTwoStepRA IEs, and indicate a separate SRS antenna switching capability in each of these FeatureCombinationPreambles IEs in which earlySRS is set to TRUE.

In some embodiments, the network can signal multiple rach-ConfigCommon/RACH-ConfigCommonTwoStepRA IEs, which indicate earlySRS set to TRUE in one or more of its FeatureCombinationPreambles IEs and indicate a separate SRS antenna switching capability in each of these FeatureCombinationPreambles IEs in which earlySRS is set to TRUE.

An example BWP-UplinkCommon information element is shown below:

BWP-UplinkCommon information element

```
-- ASN1START
-- TAG-BWP-UPLINKCOMMON-START
BWP-UplinkCommon ::=   SEQUENCE {
  genericParameters  BWP,
  rach-ConfigCommon  SetupRelease { RACH-ConfigCommon }  OPTIONAL
-- Need M
  pusch-ConfigCommon  SetupRelease { PUSCH-ConfigCommon }
OPTIONAL, -- Need M
  pucch-ConfigCommon  SetupRelease { PUCH-ConfigCommon }
OPTIONAL, -- Need M
  ...,
  [[
  rach-ConfigCommonIAB-r16  SetupRelease { RACH-ConfigCommon }
OPTIONAL, -- Need M
useInterlacePUCCH-PUSCH-r16  ENUMERATED {enabled}  OPTIONAL, -
- Need R
  MsgA-ConfigCommon-r16  SetupRelease { MsgA-ConfigCommon-r16 }
OPTIONAL -- Cond SpCellOnly2
  ]],
  [[
  enableRA-PrioritizationForSlicing-r17 BOOLEAN  OPTIONAL, -- Cond RA-
PrioSliceAI
  additionalRACH-ConfigList-r17  SetupRelease { AdditionalRACH-ConfigList-r17 }
OPTIONAL, -- Cond SpCellOnly2
  rsrp-ThresholdMsg3-r17  RSRP-Range  OPTIONAL, -- Need R
  numberOfMsg3-RepetitionsList-r17 SEQUENCE (SIZE (4)) OF NumberOfMsg3-Repetitions-
r17  OPTIONAL, -- Cond Msg3Rep
  mcs-Msg3-Repetitions-r17  SEQUENCE (SIZE (8)) OF INTEGER (0..31)
OPTIONAL, -- Cond Msg3Rep
  ]],
  [[
  additionalRACH-perPCI-ToAddModList-r18 SEQUENCE (SIZE (1..
maxNrofAdditionalPRACHConfigs-r18)) OF RACH-ConfigTwoTA-r18
                        OPTIONAL, -- Cond 2TA-Only
  additionalRACH-perPCI-ToReleaseList-r18 SEQUENCE (SIZE (1..
maxNrofAdditionalPRACHConfigs-r18)) OF RACH-ConfigTwoTAIndex-r18
                        OPTIONAL, -- Need N
  rsrp-ThresholdMsg1-RepetitionNum2-r18 RSRP-Range  OPTIONAL, -- Cond
```

Msg1Rep1

rsrp-ThresholdMsg1-RepetitionNum4-r18 RSRP-Range OPTIONAL, -- Cond

Msg1Rep1

rsrp-ThresholdMsg1-RepetitionNum8-r18 RSRP-Range OPTIONAL, -- Cond

Msg1Rep1

preambleTransMax-Msg1-Repetition-r18 ENUMERATED {n1, n2, n4, n6, n8, n10, n20, n50,
n100, n200} OPTIONAL -- Cond Msg1Rep1

]]
}

```
AdditionalRACH-ConfigList-r17 ::=  SEQUENCE (SIZE(1..maxAdditionalRACH-r17)) OF
AdditionalRACH-Config-r17
AdditionalRACH-Config-r17 ::=  SEQUENCE {
  rach-ConfigCommon-r17  RACH-ConfigCommon  OPTIONAL, -- Need R
  msgA-ConfigCommon-r17  MsgA-ConfigCommon-r16  OPTIONAL, -- Need
R
  ...
}
NumberOfMsg3-Repetitions-r17::=  ENUMERATED {n1, n2, n3, n4, n7, n8, n12, n16}
```

-- TAG-BWP-UPLINKCOMMON-STOP

```
-- ASN1STOP
RACH-ConfigCommon ::=  SEQUENCE {
  rach-ConfigGeneric  RACH-ConfigGeneric,
  totalNumberOfRA-Preambles  INTEGER (1..63)  OPTIONAL, -- Need S
  ssb-perRACH-OccasionAndCB-PreamblesPerSSB CHOICE {
    oneEighth  ENUMERATED
{n4,n8,n12,n16,n20,n24,n28,n32,n36,n40,n44,n48,n52,n56,n60,n64},
    oneFourth  ENUMERATED
{n4,n8,n12,n16,n20,n24,n28,n32,n36,n40,n44,n48,n52,n56,n60,n64},
    oneHalf  ENUMERATED
{n4,n8,n12,n16,n20,n24,n28,n32,n36,n40,n44,n48,n52,n56,n60,n64},
    one  ENUMERATED
{n4,n8,n12,n16,n20,n24,n28,n32,n36,n40,n44,n48,n52,n56,n60,n64},
    two  ENUMERATED {n4,n8,n12,n16,n20,n24,n28,n32},
    four  INTEGER (1..16)
    eight  INTEGER (1..8)
    sixteen  INTEGER (1..4)
```

| | |
|---|---|
| } | OPTIONAL, -- Need M |

```
  groupBconfigured  SEQUENCE {
    ra-Msg3SizeGroupA  ENUMERATED {b56, b144, b208, b256, b282, b480, b640,
```

b800, b1000, b72, spare6, spare5,spare4, spare3, spare2, spare1},

messagePowerOffsetGroupB ENUMERATED { minusinfinity, dB0, dB5, dB8, dB10,

| dB12, dB15, dB18}, | |
|---|---|
| numberOfRA-PreamblesGroupA-r17 INTEGER (1..64) | |
| } | OPTIONAL, -- Need R |

ra-ContentionResolutionTimer ENUMERATED { sf8, sf16, sf24, sf32, sf40, sf48, sf56,

| sf64}, | |
|---|---|
| rsrp-ThresholdSSB RSRP-Range | OPTIONAL, -- Need R |
| rsrp-ThresholdSSB-SUL RSRP-Range | OPTIONAL, -- Cond SUL |
| prach-RootSequenceIndex CHOICE { | |
| l839 INTEGER (0..837), | |
| l139 INTEGER (0..137) | |
| }, | |

| | |
|---|---|
| msg1-SubcarrierSpacing SubcarrierSpacing | OPTIONAL, -- Cond L139 |

restrictedSetConfig ENUMERATED {unrestrictedSet, restrictedSetTypeA,

| restrictedSetTypeB}, | | |
|---|---|---|
| msg3-transformPrecoder ENUMERATED {enabled} | | OPTIONAL, -- Need |
| R | | |
| ..., | | |
| [[ | | |
| ra-PrioritizationForAccessIdentity-r16 SEQUENCE { | | |
| ra-Prioritization-r16 RA-Prioritization, | | |
| ra-PrioritizationForAI-r16 BIT STRING (SIZE (2)) | | |
| } | OPTIONAL, --Cond InitialBWP-Only | |
| prach-RootSequenceIndex-r16 CHOICE { | | |
| l571 INTEGER (0..569), | | |
| l1151 INTEGER (0..1149) | | |
| } OPTIONAL -- Need R | | |
| ]], | | |
| [[ | | |

ra-PrioritizationForSlicing-r17 RA-PrioritizationForSlicing-r17 OPTIONAL, -- Cond

InitialBWP-Only

featureCombinationPreamblesList-r17 SEQUENCE {
(SIZE(1..maxFeatureCombPreamblesPerRACHResource-r17)) OF

FeatureCombinationPreambles-r17 OPTIONAL -- Cond AdditionalRACH

]]
}

```
FeatureCombinationPreambles-r17 ::= SEQUENCE {
  featureCombination-r17  FeatureCombination-r17,
  startPreambleForThisPartition-r17  INTEGER (0..63),
  numberOfPreamblesPerSSB-ForThisPartition-r17 INTEGER (1..64),
```

ssb-SharedRO-MaskIndex-r17 INTEGER (1..15) OPTIONAL, -- Need S

groupBconfigured-r17 SEQUENCE {

ra-SizeGroupA-r17 ENUMERATED {b56, b144, b208, b256, b282, b480, b640,

b800, b1000, b72, spare6, spare5,spare4, spare3, spare2, spare1},

messagePowerOffsetGroupB-r17 ENUMERATED { minusinfinity, dB0, dB5, dB8, dB10,

| dB12, dB15, dB18}, | |
|---|---|
| numberOfRA-PreamblesGroupA-r17 INTEGER (1..64) | |
| } OPTIONAL, -- Need R | |
| separateMsgA-PUSCH-Config-r17 MsgA-PUSCH-Config-r16 | OPTIONAL, -- |
| Cond MsgAConfigCommon | |
| msgA-RSRP-Threshold-r17 RSRP-Range | OPTIONAL, -- Need R |
| rsrp-ThresholdSSB-r17 RSRP-Range | OPTIONAL, -- Need R |
| deltaPreamble-r17 INTEGER (−1..6) | OPTIONAL, -- Need R |
| ..., | |
| [[ | |
| msg1-RepetitionNum-r18 ENUMERATED {n2, n4, n8} | OPTIONAL, -- Cond |
| Msg1Rep2 | |

msg1-RepetitionTimeOffsetROGroup-r18 ENUMERATED {n4, n8, n16, n32}

```
OPTIONAL -- Cond Msg1Rep3
  ]]
  [[
```

Early-SRSTxRx-r20 ENUMERATED {one or more TxRy values, e.g., 1T1R,
1T2R, 1T4R, 2T2R, 2T4R, 4T4R} OPTIONAL -- Cond EarlySRS

]]
}

In some embodiments, a BWP-UplinkCommon IE in in the BWP configuration includes one or more rach-ConfigCommon/RACH-ConfigCommonTwoStepRA IEs. The rach-ConfigCommon/RACH-ConfigCommonTwoStepRA IEs include a list of one or more FeatureCombinationPreambles IEs. The FeatureCombinationPreambles IEs include a FeatureCombination IE. the FeatureCombination IE may include an early SRS antenna switching capability (Early-SRSTxRx). Early-SRSTxRx may be set to one of the TxRy values from 1T1R, 1T2R, 1T4R, 2T2R, 2T4R, 4T4R, 1T6R, 2T6R, 1T8R, 2T8R, 4T8R, 8T8R, 3T3R, 3T6R or from a subset of 1T1R, 1T2R, 1T4R, 2T2R, 2T4R, 4T4R, 1T6R, 2T6R, 1T8R, 2T8R, 4T8R, 8T8R, 3T3R, 3T6R. If a FeatureCombination IE in a FeatureCombinationPreambles IE includes an SRS antenna switching capability (Early-SRSTxRx), the preambles configured by this FeatureCombinationPreambles IE are associated with early SRS transmission feature for that SRS antenna switching capability.

Alternatively, in some embodiments, a BWP-UplinkCommon IE in in the BWP configuration includes one or more rach-ConfigCommon/RACH-ConfigCommonTwoStepRA IEs. The rach-ConfigCommon/RACH-ConfigCommonTwoStepRA IEs include a list of one or more FeatureCombinationPreambles IEs. The FeatureCombinationPreambles IEs include a FeatureCombination IE. The FeatureCombination IE may include list of early SRS antenna switching capabilities (Early-SRSTxRx). Early-SRSTxRx may be set to one or more of TxRy values from 1T1R, 1T2R, 1T4R, 2T2R, 2T4R, 4T4R, 1T6R, 2T6R, 1T8R, 2T8R, 4T8R, 8T8R, 3T3R, 3T6R or from a subset of 1T1R, 1T2R, 1T4R, 2T2R, 2T4R, 4T4R, 1T6R, 2T6R, 1T8R, 2T8R, 4T8R, 8T8R, 3T3R, 3T6R. If a FeatureCombination IE in a FeatureCombinationPreambles IE includes an SRS antenna switching capability (Early-SRSTxRx) list, the preambles configured by this FeatureCombinationPreambles IE are associated with early SRS transmission feature for those SRS antenna switching capabilities.

In some embodiments, the UE indicates early SRS/early SRS antenna switching capability during the random access procedure (e.g., in a Msg1, MsgA or Msg3) if the random access procedure is initiated in an RRC_IDLE state. If the random access procedure is initiated in an RRC_INACTIVE or RRC_CONNECTED state, the UE does not indicate early SRS/early SRS antenna switching capability during the random access procedure.

In some embodiments, the UE indicates early SRS/early SRS antenna switching capability during the random access procedure (e.g., in a Msg1, MsgA or Msg3) if the random access procedure is initiated in an RRC_IDLE state or RRC_INACTIVE state. If the random access procedure is initiated in an RRC_CONNECTED, the UE does not indicate early SRS/early SRS antenna switching capability during the random access procedure.

In some embodiments, the UE indicates early SRS/early SRS antenna switching capability during the random access procedure (e.g., in a Msg1, MsgA or Msg3) if the random access procedure is initiated in an RRC_IDLE state or RRC_INACTIVE state and an SDT procedure is not ongoing (or the random access procedure is not for the SDT procedure).

In some embodiments, the UE indicates early SRS/early SRS antenna switching capability during the random access procedure (e.g., in a Msg1, MsgA or Msg3) if the random access procedure is initiated while the UE is not in an RRC_CONNECTED state and an SDT procedure is not ongoing (or the random access procedure is not for the SDT procedure).

In some embodiments, upon initiation of a random access procedure, the UE selects the UL/DL BWPs for the random access procedure. If the UE supports early SRS, the UE may determine whether early SRS is applicable for this random access procedure according the options below as follows:
Option 1: if the BWP selected for the random access procedure is configured with the set(s) of random access resources associated with early SRS antenna switching capability TxRy supported by the UE and the UE is not in an RRC_CONNECTED state (or alternately, if the BWP selected for the random access procedure is configured with the set(s) of random access resources associated with early SRS antenna switching capability TxRy supported by the UE and the UE is not in an RRC_CONNECTED state and an SDT procedure is not ongoing or the SDT timer is not running) (or alternately, if the BWP selected for random access procedure is configured with the set(s) of random access resources associated with early SRS antenna switching capability TxRy supported by UE and UE is in RRC_IDLE state), it is assumed that early SRS is applicable for the current random access procedure and early SRS antenna switching capability is applicable for the current random access procedure TxRy. Otherwise, it is assumed that early SRS is not applicable for the current random access procedure.
Option 2: if the BWP selected for the random access procedure is configured with the set(s) of random access resources associated with early SRS and the UE is not in an RRC_CONNECTED state (or alternately, if the BWP selected for the random access procedure is configured with the set(s) of random access resources associated with early SRS and the UE is not in an RRC_CONNECTED state and an SDT procedure is not ongoing or the SDT timer is not running) (or alternately, if the BWP selected for the random access procedure is configured with the set(s) of random access resources associated with early SRS and the UE is in an RRC_IDLE state), it is assumed that early SRS is applicable for the current random access procedure. Otherwise, it is assumed that early SRS is not applicable for the current random access procedure.

In some embodiments, if neither contention-free random access Resources nor random access Resources for an SI request have been provided for a random access procedure and one or more of the features including (e) RedCap and/or Slicing and/or SDT and/or MSG3 repetition and/or MSG1 repetition and/or early SRS is applicable for this random access procedure:
if none of the sets of random access resources are available for any feature applicable to the current random access procedure, the set(s) of random access resources that are not associated with any feature indication are selected for this random access procedure.
Otherwise, if there is one set of random access resources available which can be used for indicating all features triggering this random access procedure, this set of random access resources is selected for this random access procedure.
Otherwise, if there are more than one set of random access resources available which can be used for indicating all features triggering this random access procedure and Msg1 repetition is applicable for this random access procedure and early SRS is applicable for this random access procedure, the set of random access resources that is associated with a highest repetition number and Early-SRSTxRx capability supported by the UE among the sets of random access resources is selected.
Otherwise, if there are more than one sets of random access resources available which can be used for indicating all features triggering this random access procedure and Msg1 repetition is applicable for this random access procedure, select the set of random access resources is selected that is associated with the highest repetition number among the sets of random access resources.
Otherwise, if there are more than one set of random access resources available which can be used for indicating all features triggering this random access procedure and early SRS is applicable for this random access procedure the set of random access resources that is associated with Early-SRSTxRx capability supported by UE among the sets of random access resources is selected.
Otherwise (i.e., there are one or more sets of random access resources available that are configured with indication(s) for a subset of all features triggering this random access procedure), a set of random access resources from the available set(s) of random access resources is selected based on the priority order indicated for this random access Procedure.

In some embodiments, for core network (CN) paging, the CN/an access and mobility management function (AMF) can send the UE capability for early CSI/SRS to a gNB in an internode paging message. Alternatively, in some embodiments, for radio access network (RAN) paging, the last serving gNB of the UE can send the UE capability for early CSI/SRS to other gNBs of same RAN notification area as the last serving gNB. In embodiments such as these, when the gNB pages the UE, the gNB triggers early CSI and/or SRS while paging.

In some embodiments, separate paging-radio network temporary identifiers (P-RNTIs) for ‘paging message including early CSI/SRS trigger’ and ‘paging message not including early CSI/SRS trigger’ may be defined. For example, in some embodiments two P-RNTIs (P-RNTI 1 and P-RNTI 2) may be defined. In this example, P-RNTI 1 is for ‘paging message including early CSI/SRS trigger’. P-RNTI 2 is for ‘paging message not including early CSI/SRS trigger’.
In some embodiments, a paging message scheduled by a PDCCH addressed to P-RNTI 1, includes list of one or more PagingRecordType 1 wherein PagingRecordType 1 includes a Paging Identity and optionally an early CSI/SRS trigger. The early CSI/SRS trigger may be common or separately indicated in the paging record. If the UE's paging identity is included in one of the paging records in the list of PagingRecordType 1 and that paging record includes the early CSI/SRS trigger (or includes an early CSI/SRS trigger set to 1 or TRUE), the UE assumes that early CSI/SRS is triggered in addition to paging. For an early CSI trigger, the UE measures SSB/CSI-RS and transmits CSI to the gNB. For an early SRS trigger, the UE transmits SRS to the gNB.
Alternatively, in some embodiments, a paging message scheduled by a PDCCH addressed to P-RNTI 1 includes a list of PagingRecordType 2 wherein PagingRecordType 2 includes a Paging Identity. If the UE's paging identity is included in one of the paging records in the list of PagingRecordType 2, the UE assumes that early CSI/SRS is triggered in addition to paging. For early an CSI trigger, the UE measures SSB/CSI-RS and transmits CSI to the gNB. For an early SRS trigger, the UE transmits SRS to gNB.
In some embodiments, a paging message scheduled by a PDCCH addressed to P-RNTI 2, includes a list of one or more PagingRecordType 2 wherein PagingRecordType 2 includes a Paging Identity. If the UE's paging identity is included in one of the paging records in the list of PagingRecordType 2, the UE assumes that early CSI/SRS is not triggered in addition to paging.

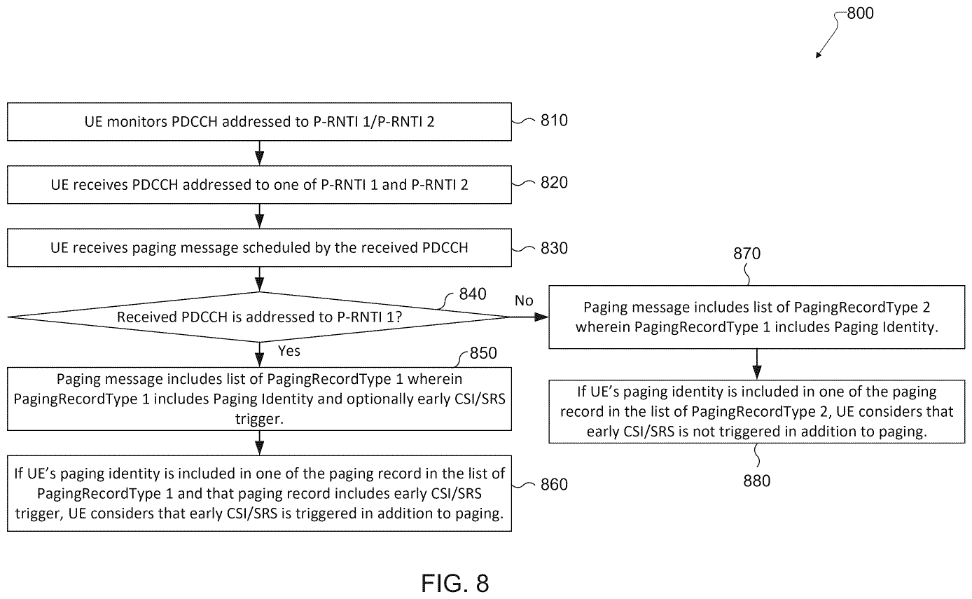

FIG. 8 illustrates an example procedure for determining an early CSI/SRS trigger 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for determining an early CSI/SRS trigger could be used without departing from the scope of this disclosure.

In the example of FIG. 8, the procedure 800 begins at operation 810. At operation 810, a UE (such as UE 116 of FIG. 1), which is in an RRC_IDLE/RRC_INACTIVE state, monitors for a PDCCH addressed to P-RNTI 1/P-RNTI 2.

At operation 820, the UE receives a PDCCH addressed to one of P-RNTI 1 and P-RNTI 2. At operation 830, the UE receives a paging message scheduled by the received PDCCH. At operation 840, the UE determines if the received PDCCH is addressed to P-RNTI 1 or P-RNTI 2.

If the received PDCCH is addressed to P-RNTI 1, at operation 850 the paging message includes a list of one or more PagingRecordType 1, wherein PagingRecordType 1 includes a Paging Identity and optionally an early CSI/SRS trigger. At operation 860, if the UE's paging identity is included in one of the paging records in the list of PagingRecordType 1 and that paging record includes an early CSI/SRS trigger (or includes an early CSI/SRS trigger set to 1 or TRUE), the UE considers that early CSI/SRS is triggered in addition to paging. The early CSI/SRS trigger may be common or separately indicated in the paging record.

If the received PDCCH is addressed to P-RNTI 2, at operation 870 the paging message includes list of one or more PagingRecordType 2 wherein PagingRecordType 2 includes Paging Identity. PagingRecordType 2 does not include an early CSI/SRS trigger. At operation 880, If the UE's paging identity is included in one of the paging records in the list of PagingRecordType 2, the UE considers that early CSI/SRS is not triggered in addition to paging.

Although FIG. 8 illustrates one example procedure for determining an early CSI/SRS trigger 800, various changes may be made to FIG. 8. For example, while shown as a series of operations, various operations in FIG. 8 could overlap, occur in parallel, occur in a different order, occur any number of times, be omitted, or replaced by other operations.

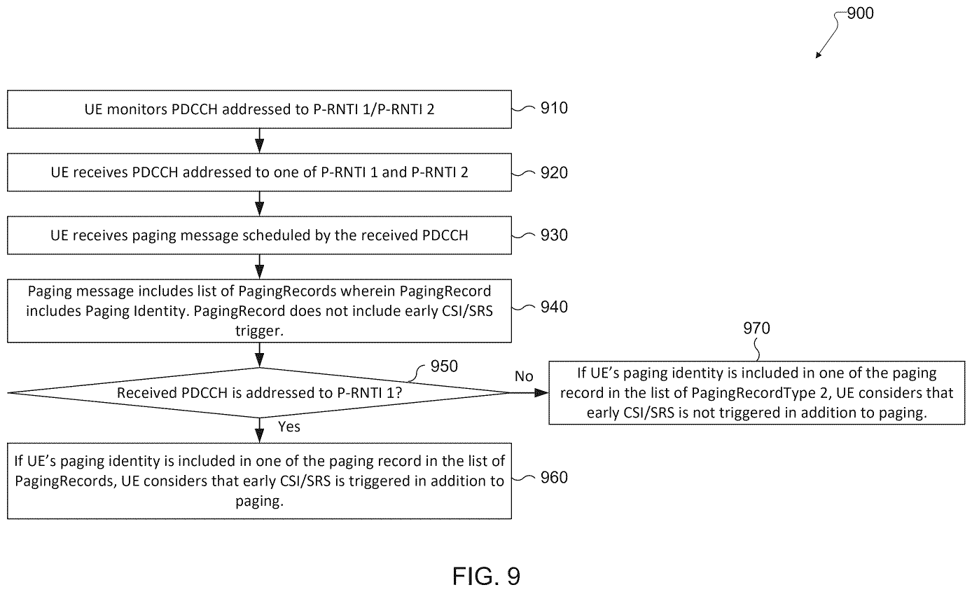

FIG. 9 illustrates another example procedure for determining an early CSI/SRS trigger 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for determining an early CSI/SRS trigger could be used without departing from the scope of this disclosure.

In the example of FIG. 9, the procedure 900 begins at operation 910. At operation 910, a UE (such as UE 116 of FIG. 1), which is in an RRC_IDLE/RRC_INACTIVE state, monitors for a PDCCH addressed to P-RNTI 1/P-RNTI 2.

At operation 920, the UE receives a PDCCH addressed to one of P-RNTI 1 and P-RNTI 2. At operation 930, the UE receives a paging message scheduled by the received PDCCH. At operation 940, the Paging message includes a list of one or more PagingRecords, wherein the PagingRecord includes a Paging Identity. The PagingRecord does not include an early CSI/SRS trigger. At operation 950, the UE determines if the received PDCCH is addressed to P-RNTI 1 or P-RNTI 2.

If the received PDCCH is addressed to P-RNTI 1 and if the UE's paging identity is included in one of the paging records in the list of PagingRecords, at operation 960, the UE considers that early CSI/SRS is triggered in addition to paging.

If the received PDCCH is addressed to P-RNTI 2 and If the UE's paging identity is included in one of the paging records in the list of PagingRecords, at operation 970 the UE considers that early CSI/SRS is not triggered in addition to paging.

Although FIG. 9 illustrates one example procedure for determining an early CSI/SRS trigger 900, various changes may be made to FIG. 9. For example, while shown as a series of operations, various operations in FIG. 9 could overlap, occur in parallel, occur in a different order, occur any number of times, be omitted, or replaced by other operations.

In some embodiments, separate P-RNTIs for ‘paging message including early CSI trigger’, ‘paging message including early SRS trigger’, and ‘paging message not including early CSI/SRS trigger’ may be defined. For example, in some embodiments, three P-RNTIs (P-RNTI 1, P-RNTI 2 and P-RNTI 3) may be defined. In embodiments such as these, P-RNTI 1 is for a paging message including an early CSI trigger. P-RNTI 2 is for paging message including an early SRS trigger. P-RNTI 3 is for a paging message not including an early CSI/SRS trigger.
In some embodiments, a paging message scheduled by a PDCCH addressed to P-RNTI 1 includes a list of one or more PagingRecordType 1, wherein PagingRecordType 1 includes Paging Identity and optionally an early CSI trigger. In embodiments such as these, PagingRecordType 1 does not include an early SRS trigger. If the UE's paging identity is included in one of the paging records in the list of PagingRecordType 1 and that paging record includes an early CSI trigger (or includes an early CSI trigger set to 1 or TRUE), the UE assumes that early CSI is triggered in addition to paging. For an early CSI trigger, the UE measures SSB/CSI-RS and transmits CSI to the gNB.
Alternatively, in some embodiments, a paging message scheduled by a PDCCH addressed to P-RNTI 1 includes a list of PagingRecordType 3, wherein PagingRecordType 3 includes a Paging Identity. If the UE's paging identity is included in one of the paging records in the list of PagingRecordType 3, the UE assumes that early CSI is triggered in addition to paging. For an early CSI trigger, the UE measures SSB/CSI-RS and transmits CSI to the gNB.
In some embodiments, a paging message scheduled by a PDCCH addressed to P-RNTI 2, includes a list of one or more PagingRecordType 2, wherein PagingRecordType 2 includes a Paging Identity and optionally an early SRS trigger. In embodiments such as these, The PagingRecordType 1 does not include an early CSI trigger. If the UE's paging identity is included in one of the paging records in the list of PagingRecordType 2 and that paging record includes an early SRS trigger (or includes an early SRS trigger set to 1 or TRUE), the UE assumes that early SRS is triggered in addition to paging. For an early SRS trigger, the UE transmits SRS to the gNB.
Alternatively, in some embodiments, a paging message scheduled by a PDCCH addressed to P-RNTI 2 includes a list of PagingRecordType 3, wherein the PagingRecordType 3 includes a Paging Identity. If the UE's paging identity is included in one of the paging records in the list of PagingRecordType 3, the UE assumes that early SRS is triggered in addition to paging. For an early SRS trigger, the UE transmits SRS to the gNB.
In some embodiments, a Paging message scheduled by a PDCCH addressed to P-RNTI 3 includes a list of one or more PagingRecordType 3, wherein the PagingRecordType 3 includes a Paging Identity. If the UE's paging identity is included in one of the paging records in the list of PagingRecordType 3, the UE assumes that early CSI/SRS is not triggered in addition to paging.

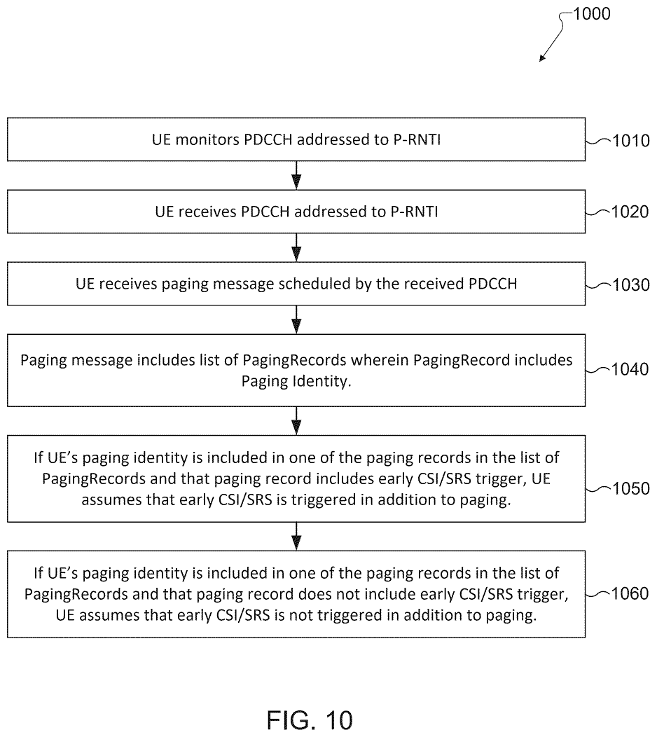

FIG. 10 illustrates another example procedure for determining an early CSI/SRS trigger 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for determining an early CSI/SRS trigger could be used without departing from the scope of this disclosure.

In the example of FIG. 10, the procedure 1000 begins at operation 1010. At operation 1010, a UE (such as UE 116 of FIG. 1), which is in an RRC_IDLE/RRC_INACTIVE state, monitors for a PDCCH addressed to a P-RNTI. At operation 1020, the UE receives a PDCCH addressed to the P-RNTI.

At operation 1030, the UE receives a paging message (with or without an early SRS/CSI trigger) scheduled by the PDCCH addressed to a P-RNTI. At operation 1040, the paging message includes a list of one or more PagingRecords, wherein PagingRecord includes a Paging Identity and optionally an early CSI/SRS trigger.

At operation 1050, if the UE's paging identity is included in one of the paging records in the list of PagingRecords and that paging record includes an early CSI/SRS trigger (or includes an early CSI/SRS trigger set to 1 or TRUE), the UE assumes that early CSI/SRS is triggered in addition to paging. For an early CSI trigger, the UE measures SSB/CSI-RS and transmits CSI to the gNB. For an early SRS trigger, the UE transmits SRS to the gNB.

At operation 1060, if the UE's paging identity is included in one of the paging records in the list of PagingRecords and that paging record does not include an early CSI/SRS trigger (or includes an early CSI/SRS trigger set to 0 or FALSE), the UE assumes that early CSI/SRS is not triggered in addition to paging.

Although FIG. 10 illustrates one example procedure for determining an early CSI/SRS trigger 1000, various changes may be made to FIG. 10. For example, while shown as a series of operations, various operations in FIG. 10 could overlap, occur in parallel, occur in a different order, occur any number of times, be omitted, or replaced by other operations.

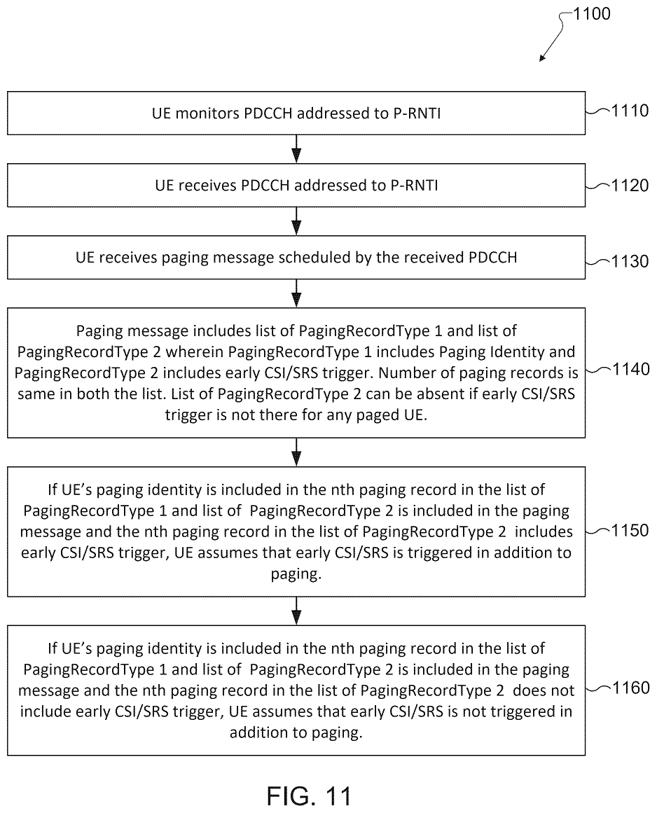

FIG. 11 illustrates another example procedure for determining an early CSI/SRS trigger 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for determining an early CSI/SRS trigger could be used without departing from the scope of this disclosure.

In the example of FIG. 11, the procedure 1100 begins at operation 1110. At operation 1110, a UE (such as UE 116 of FIG. 1), which is in an RRC_IDLE/RRC_INACTIVE state, monitors for a PDCCH addressed to a P-RNTI. At operation 1120, the UE receives a PDCCH addressed to the P-RNTI.

At operation 1130, the UE receives a paging message (with or without an early SRS/CSI trigger) scheduled by the PDCCH addressed to a P-RNTI. At operation 1140, the paging message includes list of PagingRecordType 1 and list of PagingRecordType 2, wherein PagingRecordType 1 includes a Paging Identity and PagingRecordType 2 includes an early CSI/SRS trigger. The number of paging records is same in both the lists. The list of PagingRecordType 2 can be absent if an early CSI/SRS trigger is not present for any paged UE.

At operation 1140, if the UE's paging identity is included in the n^{th} paging record in the list of PagingRecordType 1 and the list of PagingRecordType 2 is included in the paging message and the n^{th} paging record in the list of PagingRecordType 2 includes an early CSI/SRS trigger (or includes an early CSI/SRS trigger set to 1 or TRUE), the UE assumes that early CSI/SRS is triggered in addition to paging. For an early CSI trigger, the UE measures SSB/CSI-RS and transmits CSI to the gNB. For early an SRS trigger, the UE transmits SRS to the gNB. ‘n’ can be a number from 0 to X−1 where X is the number of paging records in the list, or ‘n’ can be a number from 1 to X, where X is number of paging records in the list.

At operation 1160, if the UE's paging identity is included in the n^{th} paging record in the list of PagingRecordType 1 and list of PagingRecordType 2 is included in the paging message and the n^{th} paging record in the list of PagingRecordType 2 does not include an early CSI/SRS trigger (or includes an early CSI/SRS trigger set to 0 or FALSE), the UE assumes that early CSI/SRS is not triggered in addition to paging. ‘n’ can be number from 0 to X−1, where X is the number of paging records in the list, or ‘n’ can be a number from 1 to X, where X is number of paging records in the list.

If the UE's paging identity is included in the n^{th} paging record in the list of PagingRecordType 1 and a list of PagingRecordType 2 is not included in the paging message, the UE assumes that early CSI/SRS is not triggered in addition to paging.

Although FIG. 11 illustrates one example procedure for determining an early CSI/SRS trigger 1100, various changes may be made to FIG. 11. For example, while shown as a series of operations, various operations in FIG. 11 could overlap, occur in parallel, occur in a different order, occur any number of times, be omitted, or replaced by other operations.

In some embodiments, a paging message with or without an early SRS/CSI trigger is scheduled by a PDCCH addressed to a P-RNTI. In embodiments such as these, a common early CSI/SRS trigger is included in one of a Paging DCI/PEI/LPWUS/short message for all UEs paged in the paging message. The paging message includes a list of PagingRecordType 1, wherein PagingRecordType 1 includes Paging Identity.
If an early CSI/SRS trigger is set to 1 or TRUE in the Paging DCI/PEI/LPWUS and the UE is paged in a paging message (i.e., a paging record in the list of paging records includes the UE's paging identity), the UE assumes that early CSI/SRS is triggered.
OR
If an early CSI/SRS trigger is set to 1 or TRUE in the Paging DCI/PEI/LPWUS and the UE is paged in a paging message (i.e., a paging record in list of paging records includes UE's paging identity) and UE supports early CSI/SRS, the UE assumes that early CSI/SRS is triggered.

In some embodiments, a paging message with or without an early SRS/CSI trigger is scheduled by a PDCCH addressed to a P-RNTI. An early CSI/SRS trigger is included per paging subgroup in a Paging DCI/PEI/LPWUS. The paging message includes a list of PagingRecordType 1, wherein PagingRecordType 1 includes a Paging Identity.
If an early CSI/SRS trigger is set to 1 or TRUE in a Paging DCI/PEI/LPWUS for a paging subgroup of the UE paged in the paging message (i.e., a paging record in the list of paging records includes the UE's paging identity), the UE assumes that early CSI/SRS is triggered.
OR
If an early CSI/SRS trigger is set to 1 or TRUE in a Paging DCI/PEI/LPWUS for paging a subgroup of the UE paged in the paging message (i.e., a paging record in the list of paging records includes the UE's paging identity) and the UE supports early CSI/SRS, the UE assumes that early CSI/SRS is triggered.

In some embodiments, a paging message/DCI may also include early CSI/SRS resource info. In embodiments such as these, the UE may receive/measure SSBs/CSI-RS for CSI before initiating a RACH for paging or after receiving a Msg2/MsgB or after receiving Msg4 (contention resolution).

In some embodiments, an early CSI/SRS trigger can be included in an RRCRelease message. In embodiments, the early CSI/SRS resource configuration can also be included in an RRCRelease message and this may override the configuration in SI.
The UE may receive/measure SSBs/CSI-RS for CSI after receiving a Msg2/MsgB or after receiving Msg4 (contention resolution) of an RA initiated for connection resume.
OR
If the camped cell supports early CSI/SRS (e.g., indication or early CSI/SRS configuration in SI), the UE may receive/measure SSBs/CSI-RS for CSI after receiving a Msg2/MsgB or after receiving Msg4 (contention resolution) of an RA initiated for connection resume.

In some embodiments, for a (conditional) handover/cell switch with or without a RACH, the configuration and/or the trigger for early CSI/SRS can be included in the target/candidate cell configuration (e.g., reconfiguration with sync, or pre-configuration). The UE receives early CSI or transmits SRS (during a cell switch procedure or after a cell switch is completed) based on the configuration and/or the trigger for early CSI/SRS target/candidate cell configuration when the cell switch to the target/candidate cell is triggered.

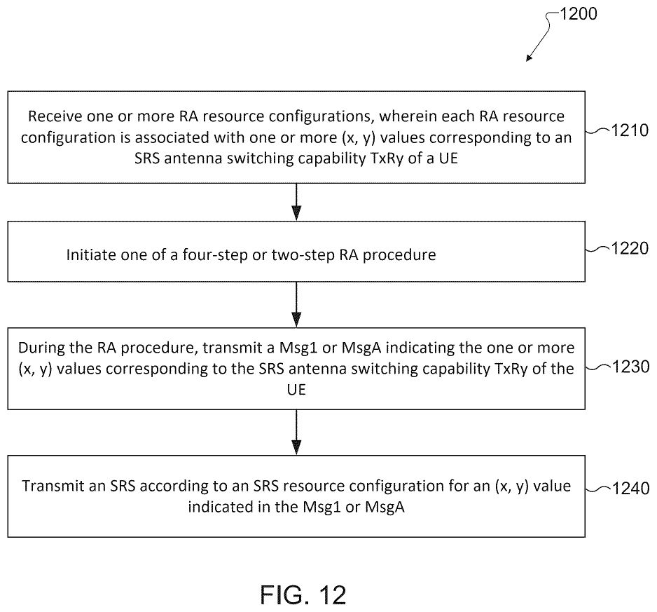

FIG. 12 illustrates an example method for early SRS transmission 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for early SRS transmission could be used without departing from the scope of this disclosure.

In the example of FIG. 12, the method 1200 begins at step 1210. At step 1210, a UE (such as UE 116 of FIG. 1) receives (e.g., from a BS such as gNB 102 of FIG. 1) one or more RA resource configurations. Each RA resource configuration is associated with one or more (x, y) values corresponding to an SRS antenna switching capability TxRy of the UE.

At step 1220, the UE initiates one of a four-step or two-step RA procedure. During the RA procedure, at step 1230, the UE transmits a Msg1 or MsgA indicating the one or more (x, y) values corresponding to the SRS antenna switching capability TxRy of the UE.

At operation 1240, the UE transmits an SRS according to an SRS resource configuration for an (x, y) value indicated in the Msg1 or MsgA.

In some embodiments, the UE may receive a Msg4 or MsgB during the RA procedure. In embodiments such as these, the SRS may be transmitted after receiving the Msg4 or MsgB.

In some embodiments, the UE may receive a trigger for SRS transmission in a Msg4 or MsgB during the RA procedure. In embodiments such as these, the SRS may be transmitted after receiving the trigger for the SRS transmission in the Msg4 or MsgB.

In some embodiments, the Msg4 or MsgB may indicate one of the (x, y) values corresponding to the SRS antenna switching capability TxRy of the UE indicated in the Msg1 or MsgA. In embodiments such as these, the SRS may be transmitted according to the SRS resource configuration for the (x, y) value corresponding to the SRS antenna switching capability TxRy of the UE indicated in the Msg4 or MsgB.

In some embodiments, random access resource configuration associated with the one or more (x, y) values corresponding to the SRS antenna switching capability TxRy of the UE is selected by the UE for transmitting the Msg1 or MsgA.

In some embodiments, the SRS resource configuration for the one or more (x, y) values is received from one of SI from a camped cell of the UE, a Msg4 or MsgB, and a stored UE context.

In some embodiments, the UE may not be in an RRC connected state when initiating the RA procedure. In embodiments such as these, the indication of the (x, y) value may be included in the Msg1 or MsgA in response to the UE initiating the RA procedure while not in the RRC connected state.

Although FIG. 12 illustrates one example method for early SRS transmission 1200, various changes may be made to FIG. 12. For example, while shown as a series of steps, various steps in FIG. 12 could overlap, occur in parallel, occur in a different order, occur any number of times, be omitted, or replaced by other steps.

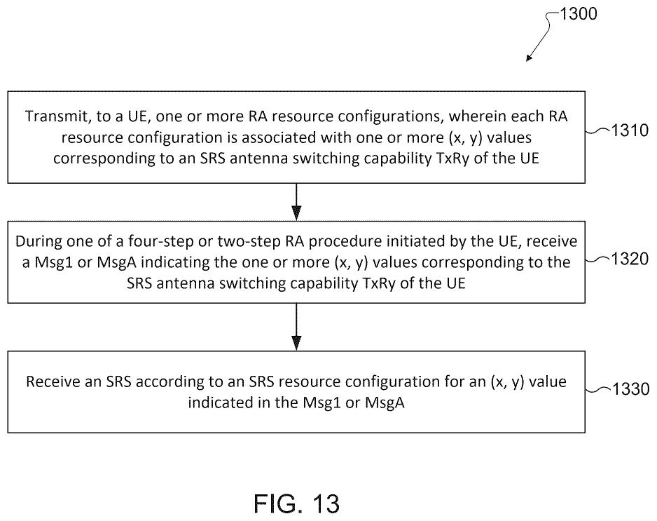

FIG. 13 illustrates another example method for early SRS transmission 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for early SRS transmission could be used without departing from the scope of this disclosure.

In the example of FIG. 13, the method 1300 begins at step 1210. At step 1210, a BS (such as gNB 102 of FIG. 1) transmits, to a UE (such as UE 116 of FIG. 1) one or more RA resource configurations. Each RA resource configuration is associated with one or more (x, y) values corresponding to an SRS antenna switching capability TxRy of the UE.

At step 1320, during the four-step or two-step RA procedure initiated by the UE, the BS receives a Msg1 or MsgA indicating the one or more (x, y) values corresponding to the SRS antenna switching capability TxRy of the UE.

At operation 1330, the BS receives an SRS according to an SRS resource configuration for an (x, y) value indicated in the Msg1 or MsgA.

In some embodiments, the BS may transmit a Msg4 or MsgB to the UE during the RA procedure. In embodiments such as these, the SRS may be received after transmitting the Msg4 or MsgB.

In some embodiments, the Msg4 or MsgB may indicate one of the (x, y) values corresponding to the SRS antenna switching capability TxRy of the UE indicated in the Msg1 or MsgA. In embodiments such as these, the SRS may be received according to the SRS resource configuration for the (x, y) value corresponding to the SRS antenna switching capability TxRy of the UE indicated in the Msg4 or MsgB.

In some embodiments, the BS may transmit a trigger for SRS transmission in a Msg4 or MsgB to the UE during the RA procedure. In embodiments such as these, the SRS may be received after transmitting the trigger for the SRS transmission in the Msg4 or MsgB.

In some embodiments, the SRS resource configuration for the one or more (x, y) values is transmitted in one of SI from a camped cell of the UE, and a Msg4 or MsgB.

In some embodiments, the UE may not be in an RRC connected state when initiating the RA procedure. In embodiments such as these, the indication of the (x, y) value may be included in the Msg1 or MsgA in response to the UE initiating the RA procedure while not in the RRC connected state.

Although FIG. 13 illustrates one example method for early SRS transmission 1300, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving one or more random access (RA) resource configurations, wherein each RA resource configuration is associated with one or more (x, y) values corresponding to a sounding reference signal (SRS) antenna switching capability TxRy of the UE;
initiating one of a four-step or two-step RA procedure;
during the RA procedure, transmitting a Message 1 (Msg1) or Message A (MsgA) indicating the one or more (x, y) values corresponding to the SRS antenna switching capability TxRy of the UE; and
transmitting an SRS according to an SRS resource configuration for an (x, y) value indicated in the Msg1 or MsgA.

2. The method of claim 1, further comprising receiving a Message 4 (Msg4) or Message B (MsgB) during the RA procedure,
wherein the SRS is transmitted after receiving the Msg4 or MsgB.

3. The method of claim 1, further comprising receiving a trigger for SRS transmission in a Message 4 (Msg4) or Message B (MsgB) during the RA procedure,
wherein the SRS is transmitted after receiving the trigger for the SRS transmission in the Msg4 or MsgB.

4. The method of claim 3, wherein:
the Msg4 or MsgB indicates one of the (x, y) values corresponding to the SRS antenna switching capability TxRy of the UE indicated in the Msg1 or MsgA; and
the SRS is transmitted according to the SRS resource configuration for the (x, y) value corresponding to the SRS antenna switching capability TxRy of the UE indicated in the Msg4 or MsgB.

5. The method of claim 1 wherein a random access resource configuration associated with the one or more (x, y) values corresponding to the SRS antenna switching capability TxRy of the UE is selected by the UE for transmitting the Msg1 or MsgA.

6. The method of claim 1, wherein the SRS resource configuration for the one or more (x, y) values is received from one of:
system information (SI) from a camped cell of the UE;
a Message 4 (Msg4) or Message B (MsgB); and
a stored UE context.

7. The method of claim 1, wherein:
the UE is not in a radio resource control (RRC) connected state when initiating the RA procedure; and
the indication of the (x, y) value is included in the Msg1 or MsgA in response to the UE initiating the RA procedure while not in the RRC connected state.

8. A method of operating a base station (BS), the method comprising:
transmitting, to a user equipment (UE), one or more random access (RA) resource configurations, wherein each RA resource configuration is associated with one or more (x, y) values corresponding to a sounding reference signal (SRS) antenna switching capability TxRy of the UE;
during one of a four-step or two-step RA procedure initiated by the UE, receiving a Message 1 (Msg1) or Message A (MsgA) from the UE indicating the one or more (x, y) values corresponding to the SRS antenna switching capability TxRy of the UE; and
receiving an SRS according to an SRS resource configuration for an (x, y) value indicated in the Msg1 or MsgA.

9. The method of claim 8, further comprising transmitting a Message 4 (Msg4) or Message B (MsgB) to the UE during the RA procedure,
wherein the SRS is received after transmitting the Msg4 or MsgB.

10. The method of claim 9, wherein:
the Msg4 or MsgB indicates one of the (x, y) values corresponding to the SRS antenna switching capability TxRy of the UE indicated in the Msg1 or MsgA; and
the sounding reference signal (SRS) is received according to the SRS resource configuration for the (x, y) value corresponding to the SRS antenna switching capability TxRy of the UE indicated in the Msg4 or MsgB.

11. The method of claim 8, further comprising transmitting a trigger for SRS transmission in a Message 4 (Msg4) or Message B (MsgB) to the UE during the RA procedure,
wherein the SRS is received after transmitting the trigger for the SRS transmission in the Msg4 or MsgB.

12. The method of claim 8, wherein the SRS resource configuration for the one or more (x, y) values is transmitted in one of:
system information (SI) from a camped cell of the UE; and
a Message 4 (Msg4) or Message B (MsgB).

13. The method of claim 8, wherein:
the UE is not in a radio resource control (RRC) connected state when initiating the RA procedure; and
the indication of the (x, y) value is included in the Msg1 or MsgA in response to the UE initiating the RA procedure while not in the RRC connected state.

14. An electronic device comprising:
at least on processor including processing circuitry; and
memory storing instructions, wherein the instructions, when executed by the at least one processor individually or collectively, cause the electronic device to:
receive one or more random access (RA) resource configurations, wherein each RA resource configuration is associated with one or more (x, y) values corresponding to a sounding reference signal (SRS) antenna switching capability TxRy of the electronic device;
initiate one of a four-step or two-step RA procedure;
during the RA procedure, transmit a Message 1 (Msg1) or Message A (MsgA) indicating the one or more (x, y) values corresponding to the SRS antenna switching capability TxRy of the electronic device; and
transmit an SRS according to the SRS resource configuration for an (x, y) value indicated in the Msg1 or MsgA.

15. The electronic device of claim 14, wherein the instructions, when executed by the at least one processor individually or collectively, further cause the electronic device to:
receive a Message 4 (Msg4) or Message B (MsgB) during the RA procedure; and
transmit the SRS after receiving the Msg4 or MsgB.

16. The electronic device of claim 14, wherein:
the Msg4 or MsgB indicates one of the (x, y) values corresponding to the SRS antenna switching capability TxRy of the UE indicated in the Msg1 or MsgA; and
the sounding reference signal (SRS) is transmitted according to an SRS resource configuration for the (x, y) value corresponding to the SRS antenna switching capability TxRy of the UE indicated in the Msg4 or MsgB.

17. The electronic device of claim 14, wherein the instructions, when executed by the at least one processor individually or collectively, further cause the electronic device to:
receive a trigger for SRS transmission in a Message 4 (Msg4) or Message B (MsgB) during the RA procedure; and
transmit the SRS after receiving the trigger for the SRS transmission in the Msg4 or MsgB.

18. The electronic device of claim 14, wherein a random access resource configuration associated with the one or more (x, y) values corresponding to the SRS antenna switching capability TxRy of the electronic device is selected by the electronic device for transmitting the Msg1 or MsgA.

19. The electronic device of claim 14, wherein a SRS resource configuration for the one or more (x, y) values is received from one of:
system information (SI) from a camped cell of the electronic device;
a Message 4 (Msg4) or Message B (MsgB); and
a stored UE context.

20. The electronic device of claim 14, wherein:
the electronic device is not in a radio resource control (RRC) connected state when initiating the RA procedure; and
the indication of the (x, y) value is included in the Msg1 or MsgA in response to the electronic device initiating the RA procedure while not in the RRC connected state.
